(19) United States
(12) Patent Application Publication
(10) Pub. No.: US 2022/0311369 A1
(43) Pub. Date: Sep. 29, 2022

(54) MULTI-PHASE CONTROL OF AN ELECTRIC MACHINE

(71) Applicant: Tula eTechnology, Inc., San Jose, CA (US)

(72) Inventor: Paul CARVELL, San Jose, CA (US)

(21) Appl. No.: 17/682,742

(22) Filed: Feb. 28, 2022

Related U.S. Application Data
(60) Provisional application No. 63/164,839, filed on Mar. 23, 2021.

(51) Int. Cl. H02P 25/22; H02K 1/16; H02K 1/18; H02K 1/26; H02K 3/28

(52) U.S. Cl. CPC H02P 25/22; H02K 1/165; H02K 1/182; H02K 1/26; H02K 3/28

(57) ABSTRACT

Methods, controllers and electric machine systems are described for multi-phase control of electric machines (e.g., electric motors and generators).

### CROSS-REFERENCE TO RELATED APPLICATION

This application claims the benefit of priority of U.S. Application No. 63/164,839, filed Mar. 23, 2021, which is incorporated herein by reference for all purposes.

### BACKGROUND

The present application relates generally to the control of electric machines, and more particularly, to virtual pole changing using multi-phase control in an electric motor and electric machines configured to support such operation.

Electric motors and generators are structurally very similar. Both include a stator having a number of poles and a rotor. Most electrical motors can operate as a generator and vice-versa. When operating as a motor, electrical energy is converted into mechanical energy. When operating as a generator, mechanical energy is converted into electrical energy. The term “machine” as used herein is therefore intended to be broadly construed to mean both electric motors and generators.

Electric motors and generators are used in a very wide variety of applications and under a wide variety of operating conditions. In general, many modern electric machines have relatively high energy conversion efficiencies. The energy conversion efficiency of most electric machines, however, can vary considerably based on their operational load. With many applications, an electric machine is required to operate under a wide variety of different operating load conditions. As a result, many electric machines operate at or near the highest levels of efficiency at certain times, while at other times, they operate at lower efficiency levels.

Electric machines generally operate using either direct current (DC) or alternating current (AC). Representative DC machines include brushless, electrically excited, permanent magnet, series wound, shunt, brushed, compound, and others. With AC machines, there are two general varieties, asynchronous and synchronous. An example of an asynchronous electric machine is a three-phase induction motor.

One issue in electric machines is a phenomenon known as air gap flux. For efficient operation of electromagnetic devices, it is desirable for the magnetic circuit to contain materials (such as iron) offering low resistance to the passage of magnetic flux. This minimizes the amount of electrical energy needed to create the magnetic field. Gaps or air in the magnetic circuit have a high resistance to magnetic flux (“air gap flux”), resulting in undesirable increases in magnetizing current and the associated electrical loss. However, gaps in the magnetic circuit of many electric machines are normally unavoidable. This is particularly true in motors and generators. The air gap needed to separate the revolving rotor from the stator should be as small as possible to reduce the magnetizing power requirement, yet large enough to prevent contact between the two despite manufacturing tolerances on their dimensions, or movement resulting from mechanical deflection and looseness in supporting bearings. In sizing the air gap for conventional induction motors, the general convention is that the higher the speed, the larger the air gap. This can present problems for electric machines operating at varying speeds and torques, and thus presents the need to spatially change the air gap flux, ideally “on the fly”, based on the varying output demands of the motor.

One current technique used to address this problem involves the summation of multiple-phase winding-induced magnetic motive force (MMF) to control the air gap flux. The current practice is for one phase winding to be looped through many slots so that such it contributes to the air gap flux in many places within the circumference of the motor and thereby any changes in the induced MMF will affect the air gap flux in multiple places. For a three-phase induction motor, affecting spatial changes are limited to multi-phase switching i.e. 9 to 6 to 3 phases and vice versa. Such switching is discrete—generally involving multiple 3-phase inverters. It also suffers from transient conditions and/or requires the motor to be stationary during the change—negating the ability to switch to a different output “on the fly.”

Accordingly, a need therefore exists to operate electric machines, such as motors and generators, at higher levels of efficiency.

### SUMMARY

A variety of methods, controllers and electric machine systems are described for multi-phase control of electric machines (e.g., electric motors and generators).

In one non-exclusive embodiment, a method of operating an electric machine includes controlling the current in each dedicated coil associated with an individual stator slot and its phase relationship to that of adjoining slots to thereby control one or more of the resultant air gap flux amplitude, wave shape, and spatial relationship at each stator slot and/or coil. By reducing the winding location to a single slot, the induced magneto motive force produced by the winding only affects changes in the air gap flux close to that slot rather than multiple radial locations, thus allowing optimal control over the air gap flux around the entirety of the air gap interface between the stator and rotor.

### BRIEF DESCRIPTION OF THE DRAWINGS

The technology described herein and the advantages thereof, may best be understood by reference to the following description taken in conjunction with the accompanying drawings in which:

FIG. 1 is a functional block diagram illustrating a multi-phase electric machine control system in accordance with a non-exclusive embodiment of the present description.

FIG. 2 illustrates an exemplary schematic side view of an electric machine in the form of a stator for an electric induction motor to be operated by the multi-phase electric machine control system of FIG. 1. The rotor and other components/wiring are omitted for clarity.

FIG. 3A is a detailed side view of the stator of FIG. 2, with the rotor included.

FIG. 3B is a detailed side view of an alternative stator having stator windings wrapped around the teeth of the stator.

FIG. 4 is a schematic diagram of an exemplary star winding wiring configuration for the individual stator windings of the stator shown in FIG. 3A.

FIG. 5A is a plot of the spatial distribution for one stator winding in a stator having 36 individual stator windings operating at a single pole pair.

FIG. 5B is a plot of the phase excitation for each of the 36 individual stator windings of the stator of FIG. 5A, operating at a single pole pair and 36 phase excitation.

FIG. 6A is a plot of the spatial distribution for one stator winding in a stator having 36 individual stator windings operating at 6 pole pairs.

FIG. 6B is a plot of the phase excitation for each of the 36 individual stator windings of the stator of FIG. 6A, operating at 6 pole pairs and 6 phase excitation.

FIG. 7A is a plot of the spatial distribution for one stator winding in a stator having 36 individual stator windings operating at 9 pole pairs.

FIG. 7B is a plot of the phase excitation for each of the 36 individual stator windings of the stator of FIG. 7A, operating at 9 pole pairs and 4 phase excitation.

FIG. 8A is a plot of the spatial distribution for one stator winding in a stator having 36 individual stator windings, and transitioning from a single pole pair to 2 pole pairs.

FIG. 8B is a plot of the phase excitation for each of the 36 individual stator windings of the stator of FIG. 8A while transitioning from a single pole pair to 2 pole pairs.

FIG. 8C is a plot of the spatial distribution for all stator windings in a stator having 36 individual stator windings while transitioning from a single pole pair to 2 pole pairs.

FIG. 9 is a plot of torque-speed curves for differing pole pair configurations.

FIG. 10 is a plot of the summation of the torque-speed curve utilizing pole count changing.

In the drawings, like reference numerals are sometimes used to designate like structural elements. It should also be appreciated that the depictions in the figures are diagrammatic and not to scale.

### DETAILED DESCRIPTION

The present application relates generally to virtual pole changing via multi-phase control that may be implemented in a wide variety of electric machines (e.g., electric motors and generators).

For the sake of brevity, the multi-phase control of electric machines as provided herein is described in the context of an electric induction motor. This exemplary configuration, however, should not be construed as limiting in any regard. On the contrary, the multi-phase control as described herein can be used for many types of electric machines, meaning both electric motors and generators. For instance, the machine as described herein may be used with any type of AC (e.g., induction, synchronous, etc.) machine. In addition, pulsed control of such electric machines may be used in a number of applications. In particular, the same or similar multi-phase control strategies, as described herein, may be used in systems that vary significantly with respect to acceleration and deceleration rates for applications ranging from vehicles to electric motors for heating, cooling, and ventilating systems and appliances like compressors, washing machines, dryers and dishwashers.

### Multi-Phase Induction Machine

An induction machine generally includes two main components, a stationary stator, and a rotating rotor. In a typical three-phase machine, the stator may include a three-coil winding that is excited by a three-phase AC input, wherein each of the three coils are wound “windings” about multiple locations in the slots for a stator. For example, for a 36 slot stator, each of the three coils will occupy 12 radially-spaced locations along the stator, e.g. at individual stator slots or around stator “teeth” separating each slot. Thus, the current delivered through an individual winding will generate the same induced magnetic motive force (MMF) at each of the 12 radially-spaced locations. When the three-phase AC input is passed through the three-phase winding, a rotating magnetic field (RMF) is generated. The rotational rate of the RMF is known as the synchronous speed (Nₛ) of the electric machine. The rotor is typically either a “squirrel cage” or a “wound” type rotor, both having a plurality of electrically conductive elements that are electrically shorted at their ends. In accordance with Faraday's law, the RMF induces a current within the conductive elements of the rotor. The induced current establishes an induced magnetic field, which interacts with the magnetic field produced in the stator coils. The interaction of the rotor and stator magnetic fields generates an electromagnetic force (EMF) causing the rotor rotation. This type of motor is called an induction motor because electrical current is induced on the rotor conductive elements by electromagnetic induction, as opposed to a direct electrically conductive path.

Induction motors provide a number of advantages. First, they are inherently self-starting. Second, the rotational speed of the rotor is easy to control. The rotational speed of the rotor (Nᵣ) is always slightly less than the synchronous speed (Nₛ). This difference is known as slip, which may be expressed in terms of a percentage:

Slip %=(Nₛ−Nᵣ)/Nₛ Eq. (1)

The frequency of the AC power energizing the stator windings controls the RMF rotational rate and thus the synchronous frequency. In turn, the rotational speed of the rotor can be controlled based on Eq. (1) defined above.

While the frequency provided to the winding controls the synchronous speed (Nₛ), the amplitude of the applied AC controls the output torque of the electric machine. When the amplitude is higher or lower, the output of the machine is higher or lower, respectively.

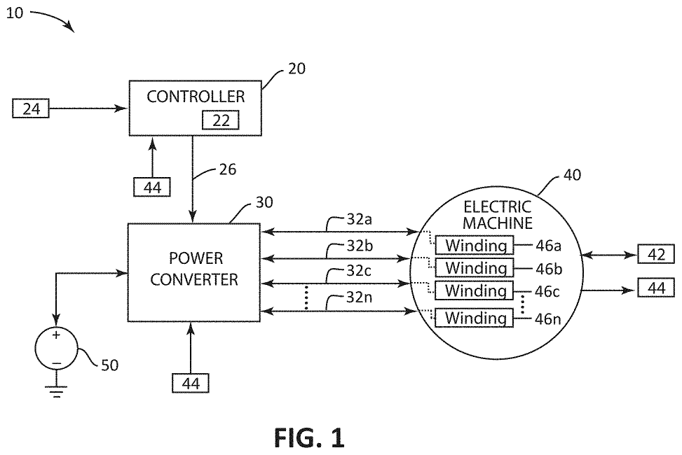

FIG. 1 illustrates a multi-phase electric machine control system in accordance with a non-exclusive embodiment of the present technology. In this embodiment, the system 10 includes a machine controller 20, a power supply/sink 50, a power converter 30, and an electric machine 40.

When the electric machine 40 is operated as a motor, the machine controller 20 functions as a motor controller, and the power converter 30 is responsible for converting power 26 received from power supply 50 to a form that is suitable for driving the electric machine 40. The multi-phase input power, labeled as dedicated line 32a, line 32b, and line 32c . . . line 32n, is applied to respective individual stator windings 46a, 46b, 46c . . . 46n (where n=the number of windings and corresponding stator slots) of the stator of the electric machine 40 for generating the Rotating Magnetic Field (RMF) used to drive the electric machine 40 and individually control the stator windings 46a, 46b, 46c . . . 46n to provide virtual pole changing in response to various demands for the machine. Each dedicated line 32a, 32b, 32c, up to 32n provides independent control of each winding 46a, 46b, 46c, up to 46n such that each winding may be operated at its own phase for up to n phases. The dedicated lines depicting the various possible phases, e.g. 32a, 32b, 32c, up to 32n are shown with arrows on both ends indicating that current can flow both from the power converter 30 to the electric machine 46 when the machine is used as a motor and that current can flow from the electric machine 46 to the power converter 30 when the machine is used as a generator. When the electric machine 40 is operated as a generator, the machine controller 20 functions as a generator controller and the power converter 30 converts power received from the generator to a form suitable for delivery to the power sink 50.

In embodiments in which the power supply/sink 50 can supply or receive power directly in the form required by or outputted by the electric machine 40, the power converter 30 can conceptually take the form of a switch or logical multiplier that simply turns the motor on and off to facilitate operation of the electric machine 40.

The power supply/sink 50 can take any suitable form. In some implementations, the power supply/sink 50 may take the form of a battery or a capacitor. In other implementations, the power supply/sink 50 may be a power grid (e.g., “wall power”), a photovoltaic system, or any other available source. Similarly, the sink may be an electrical load (such as an electrically operated machine or appliance, a building, a factory, a home, etc.), a power grid or any other system that uses or stores electrical power.

The power converter 30 can also take a wide variety of different forms. When the power supply/sink 50 is a DC power supply and the electric machine 40 is an AC motor, the power converter 30 can take the form of an inverter. Conversely, when the power supply/sink 50 is a DC power sink and the electric machine 40 is an AC generator, the power converter 30 can take the form of a rectifier. When both the power supply/sink 50 and the electric machine are AC components, the power converter 30 may include a bidirectional or 4 quadrant power converter.

In FIG. 1, the requested output or demand 24, along with motor/generator speed 44 may be input and/or provide feedback to the machine controller 20. The torque delivered 42 or received by the electric machine 40 may also be measured and provide feedback for the system 10. In some embodiments, the machine controller 20 includes an application programming 22 that is stored in memory (not shown) and executable on a processor (not shown) to provide timing and/or other signal processing of one or more aspects of the current/signals to each of the stator windings 46a, 46b, 46c . . . 46n to operate the electric machine at optimal efficiency and other performance characteristics or parameters. In response to a currently requested output 24 as well as the input of motor speed 44 provided to the machine controller 20 and power converter 30, the machine controller 20 as directed by instructions in application programming 22 may structure the timing and number of phases to the individual stator windings 46a, 46b, 46c . . . 46n and affect changes to the pole pair count of the electric machine 40 to meet the demand of the requested output 24.

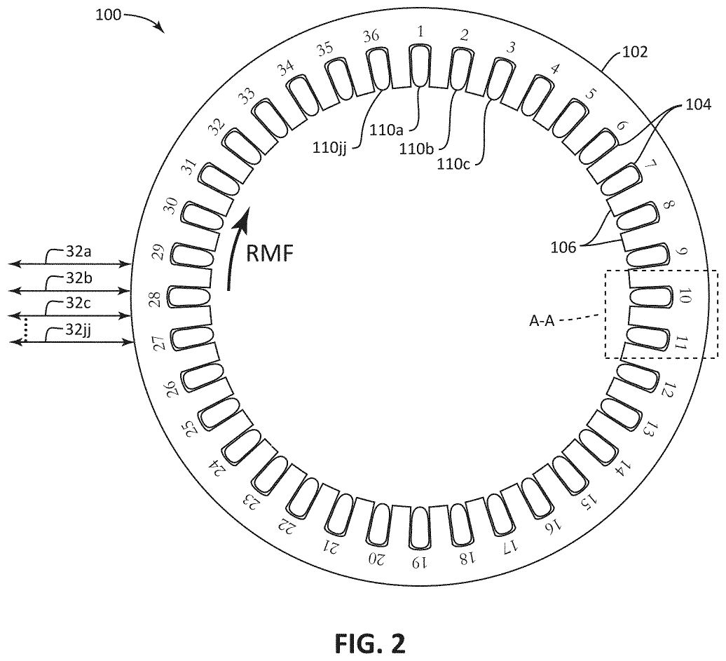

FIG. 2 shows a schematic side view of a stator 102 for an electric induction motor 100 to be operated as electric machine 40 in the multi-phase electric machine control system 10 of FIG. 1. For the sake of clarity, FIG. 1 provides a simplified diagram of a stator 102 with the rotor and other components/wiring being omitted. As shown in FIG. 2, stator 102 includes n=36 stator slots that are disposed along radially spaced-apart circumferential locations of the stator 102. It is appreciated that the stator 102 may comprise any number n of stator slots (e.g. n=18, 24, 48, 64, 72, etc.), but is preferably larger than 8 to provide pole count variation and control of the air gap flux. Each pair of adjacent stator slots 104 form a stator tooth 106. In one embodiment, stator 102 is composed of a laminated stack of stator discs disposed insulated with respect to each other along the axis of the stator 102. In a further embodiment, the stator 102 laminations or discs are composed of steel or like material.

As further shown in FIG. 2, each stator slot 104 (labeled 1-36) houses an individual, dedicated stator winding 110a (1^{st} stator slot) through 110jj (36^{th} stator slot), with each stator winding 110a through 110jj being independently wired to controller 20 via corresponding dedicated lines 32a through 32jj such that each winding 110a through 110jj may be independently operated at its own phase for a total of 36 phases and operated in a manner to generate the rotating magnetic field (RMF) that operates to induce rotation of the rotor. For example, for a 72-slot stator (not shown), 72 stator windings would be provided for each of the slots and independently wired to the controller via 72 dedicated lines.

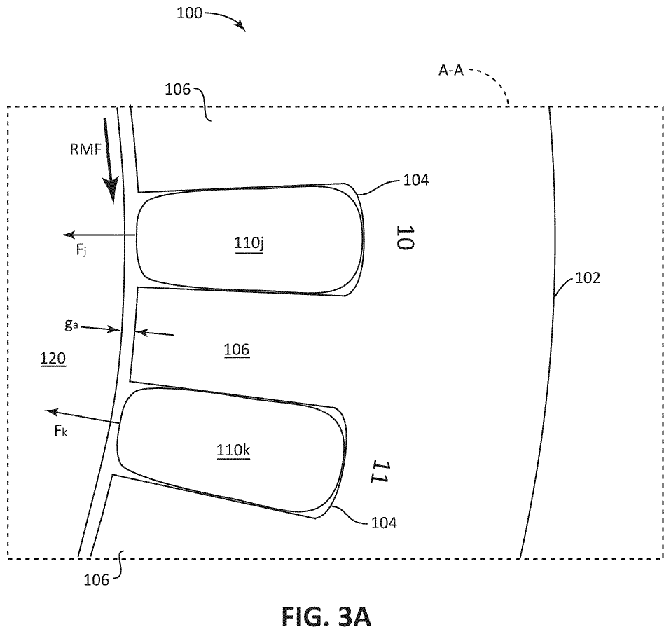

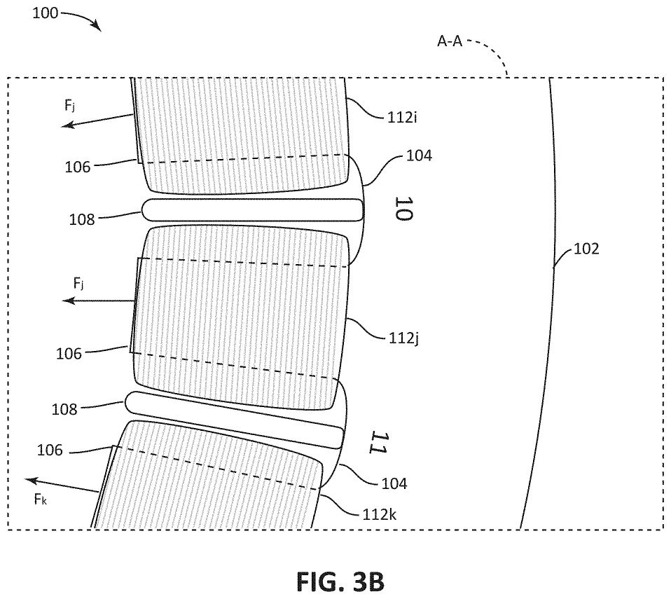

It is appreciated that “stator winding” as used in the description provided herein may be implemented as a traditional multi-wind “coil” or “winding” commonly used in stator design, but may also be a solid or non-wound or non-coiled structure, as long as it provides a conductive structure (e.g. copper composition to allow for current to pass through). For example, in the embodiment shown in FIG. 2 and detail view of FIG. 3A, the stator windings 110a through 110jj may comprise a cast or machined structure that mostly consumes the volume of the stator slot 104 in which it resides. Alternatively, each stator winding may comprise a coiled structure (e.g. stator windings 112a through 112jj) that winds around a stator tooth 106 separating a pair of stator slots 104.

Referring to FIG. 3A, a detailed side view of section A-A of FIG. 2 is provided, showing greater detail of the stator slots 104 (in particular 10^{th} and 11^{th} stator slots out of the 36) of the stator 102. As seen in FIG. 3A, the solid construction (e.g., cast/machined or like structure) consumes much of the volume of the stator slot 104 in which it resides. Such construction minimizes the amount of insulation that would typically be used, resulting in a very high slot fill factor. This reduces possible copper losses and enables the electric machine to run at high power for the same losses. In other words, the machine's efficiency increases compared to a multi-turn winding. However, if the single winding is too large, the skin effect may drive up the AC resistance, negating some or all of the aforementioned advantages.

FIG. 3A also details the air gap gₐ, or annular space between the stator 102 inner circumference and rotor 120 outer circumference. The rotor 120 may include an array of radially spaced apart rotor slots (not shown for clarity) and magnetically responsive elements having a location and number corresponding to the number n of stator slots 104. The dedicated stator winding 110j in the 10^{th} stator slot and stator winding 110k in the 11^{th} stator slot are independently operable via controller 20 and dedicated lines 32j and 32k respectively, and thus the current passing through them may be independently timed according to a specified/desired pole pair spatial distribution and phase excitation with respect to each other and remaining adjacent stator windings 110/slots 104, thus the magneto motive force (MMF) may be individually controlled at the location of each stator slot. I.e., the MMF's corresponding to slots 10 and 11 (Fⱼ and Fₖ respectively) are independently controllable so as to affect the air gap gₐ flux at the individual locations of stator windings 110j and stator winding 110k. Thus, by directly controlling the individual current, and hence MMF, of each stator slot 104, the phase relationship of adjacent slots/phases can be changed and hence the change the effective pole count of the motor. Modifying the pole count on the fly provides a “virtual gearing” of the motor, providing increased efficiency, and allowing a high starting current combined with high speed in the same. Furthermore, precisely controlled timing of the phase of the individual slots via advancing or retarding the phase shift between adjacent slots allows for a smooth, incremental transition between changes in induced pole count integer values.

Referring now to FIG. 3B, a detailed side view B-B of an alternative stator configuration is shown having coil-type stator windings 112a through 112jj wrapped around individual stator teeth 106 of the stator. As with the embodiment shown in FIG. 3A, the dedicated stator windings 112a through 112jj (e.g. stator winding 112i around stator tooth 106 between 9^{th} and 10^{th} stator slots, stator winding 112j around stator tooth 106 between 10^{th} and 11^{th} stator slots, and stator winding 112k around stator tooth 106 between 11^{th} and 12^{th} stator slots) are also independently operable via controller 20 and dedicated lines 32a and 32jj respectively, and thus the current passing through them may be independently timed according to a specified/desired pole pair spatial distribution and phase excitation with respect to each other and remaining adjacent stator windings 112/slots 104, and thus the magneto motive force (MMF) may be individually controlled at the location of each stator tooth 106. I.e., the MMF's corresponding to stator teeth 106 between 9^{th} and 10^{th}, 10^{th} and 11^{th}, and 11^{th} and 12^{th} stator slots (Fi, Fⱼ and Fₖ respectively) are independently controllable so as to control the air gap gₐ flux at the individual locations of stator windings 112i, 112j and 112k. Thus, by directly controlling the individual current, and hence MMF, of each stator tooth 106, the phase relationship of adjacent teeth/phases can be changed and hence the effective pole count of the motor to provide the same virtual gearing benefits of the embodiment illustrated in FIG. 3A.

One particular advantage of the embodiment of FIG. 3B is that multiple turns per winding may be accommodated, and hence the motor can be designed for high voltage applications. However, an increase in the insulation (e.g. insulating barriers 108) have the affect of reducing the copper fill and hence the motor efficiency. Additionally, for high voltage applications, there will likely be a need for larger creepage and clearance for Direct Copper Bonded (DCB) power stages, if used.

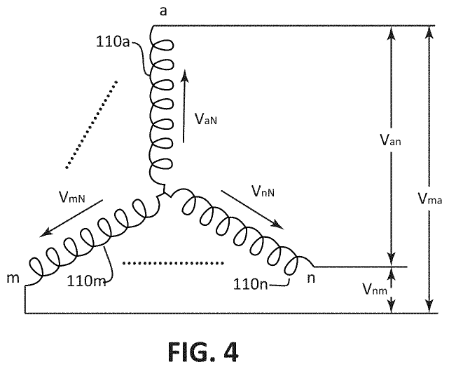

FIG. 4 is a schematic diagram of an exemplary star winding wiring configuration for the individual stator windings 110a-110n of the stator, e.g. for stator windings shown in FIG. 2 and FIG. 3a where n=36. It is appreciated that the same wiring configuration may also be implemented for the stator windings 112a-112jj of FIG. 3B. In this embodiment, all windings (e.g. 110a-110n) are arranged to form a star, with all the windings shorted together at one end of the stator 102, the resultant currents all cancelling each other out at the star point. For each of the solid stator windings illustrated in FIG. 3A, a machined, cast or otherwise contiguous winding structure may be used wherein an electrically conductive ring (e.g. copper or the like) may be formed as a base (not shown) configured to be positioned at one end of the stator 102, with the individual stator windings 110a-11On being integral with the base to form the “star point” shown in the embodiment of FIG. 4, individual stator windings 110a-11On extending generally perpendicular to the base so as to extend axially into the radially spaced-apart stator slot 104 locations substantially along the axial length (not shown) of the stator 102 when positioned at one end of the stator 102.

### Multi-Phase Control of Pole Pair Count

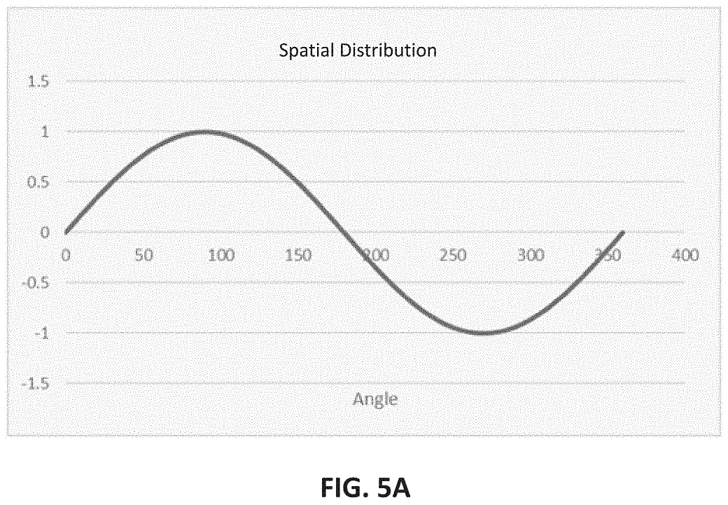

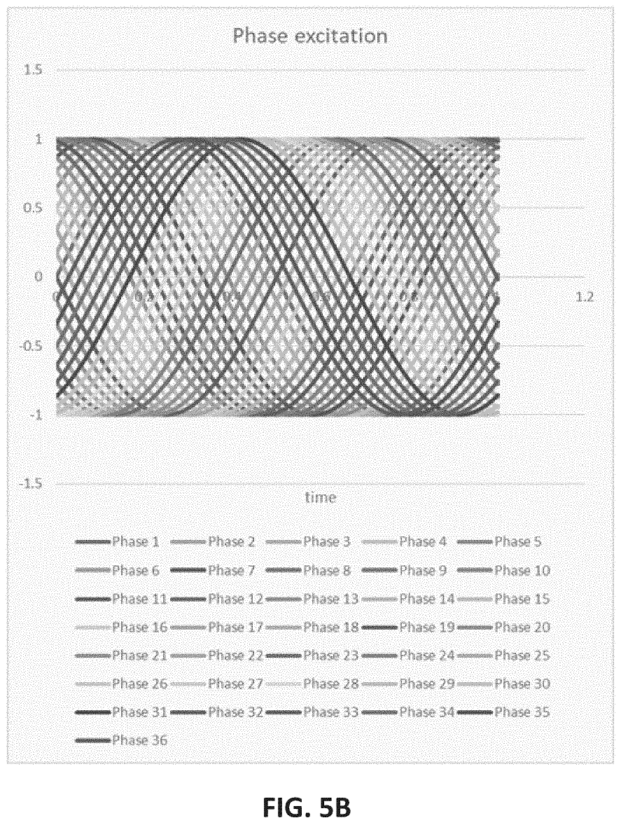

Considering the standard 36-slot stator 102 shown in FIG. 2 and FIGS. 3A and 3B, a 1 pole pair stator may be generated by delivery of individual current signals to the independently wired windings 110a/112a-110jj/112/jj by phase shifting the current in the adjacent windings by 360*1/36=10 electrical degrees. Correspondingly, and a 2-pole pair stator may be generated by delivery of individual current signals to the independently wired stator windings 110a/112a-110jj/112/jj by phase shifting the current in the adjacent windings by 360*2/36=20 electrical degrees, etc. as will be detailed in the following MMF spatial distribution and phase excitation plots provided in FIG. 5A through FIG. 7B. It is appreciated that controller and associated application programming 22 (FIG. 1) may be configured to generate current and/or phase signal profiles to the stator windings 110a/112a-110jj/112/jj and transition between various current and/or phase signal profiles in response

FIG. 5A is a plot of an exemplary spatial distribution for one stator winding in the 36-winding stator operating at a single pole pair. FIG. 5B shows an exemplary the spaced apart phase excitation (e.g. at 10 degrees spacing) for each of the 36 individual stator windings of the stator of FIG. 5A, operating at a single pole pair and 36-phase excitation.

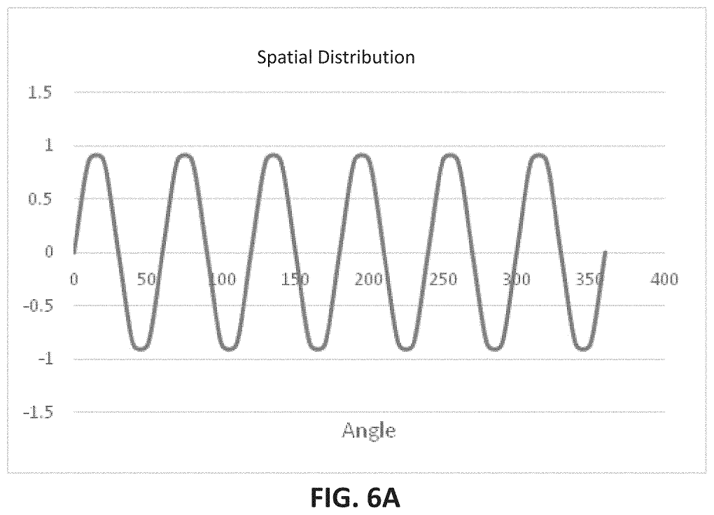

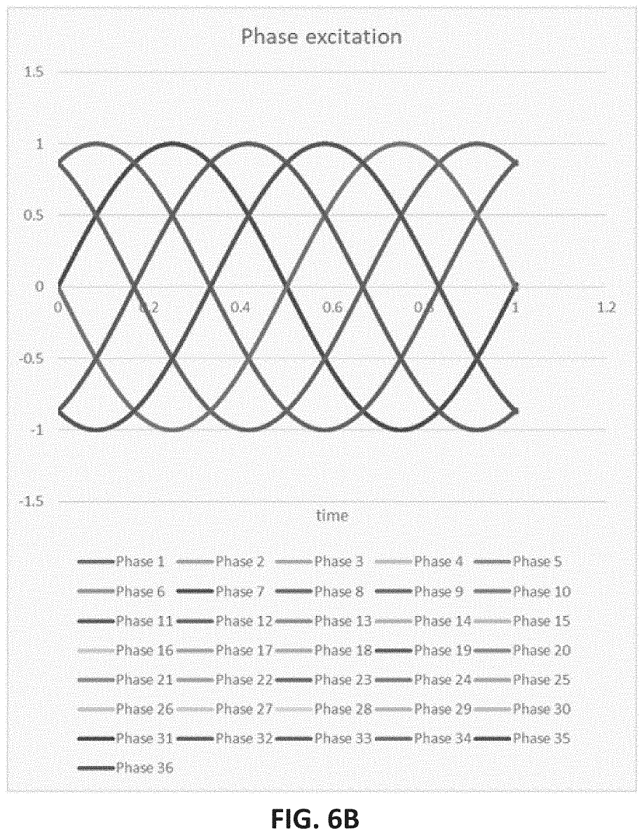

FIG. 6A is a plot of an exemplary spatial distribution for one stator winding in the 36-winging stator operating at 6 pole pairs. FIG. 6B shows an exemplary spaced-apart phase excitation (e.g. at 60 degrees spacing) for each of the 36 individual stator windings of the stator of FIG. 6A, operating at 6 pole pairs and 6 phase excitation.

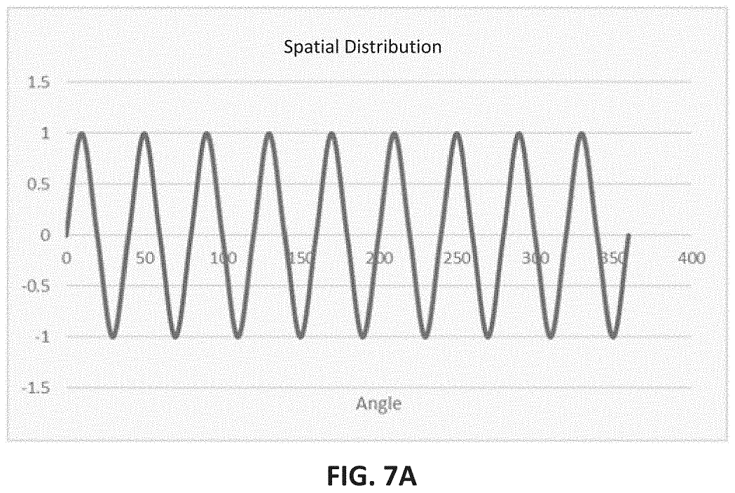

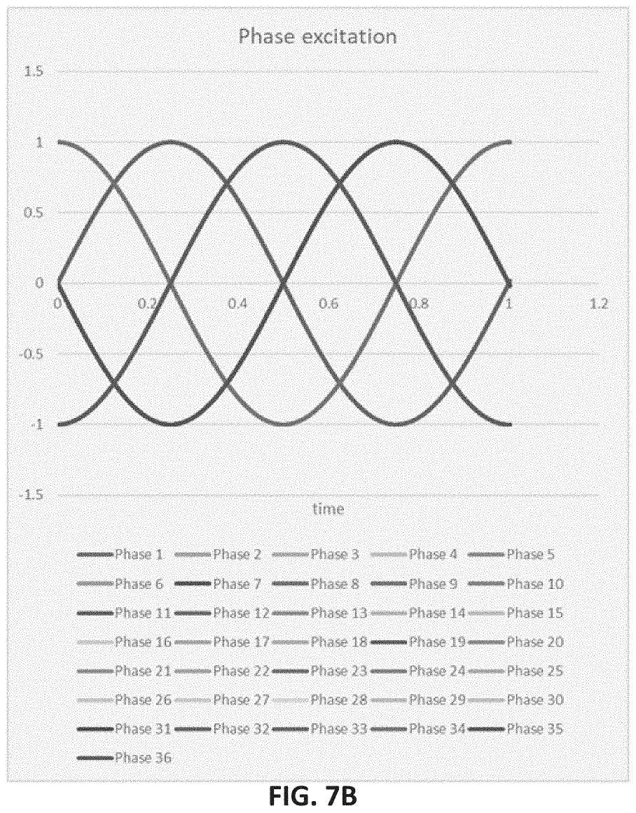

FIG. 7A is a plot of an exemplary spatial distribution for one stator winding in the 36-winging stator operating at 9 pole pairs. FIG. 7B shows an exemplary spaced-apart phase excitation (e.g. at 90 degrees spacing) for each of the 36 individual stator windings of the stator of FIG. 7A, operating at 9 pole pairs and 4 phase excitation.

As can be seen from the spatial distribution and phase excitation plots detailed above for in FIG. 5A through FIG. 7B, as the pole pair count increases, the MMF spatial distribution defining the number of poles increases in frequency while the phase excitation remains the same, whilst the number of phase excitations patterns reduces. For example, for the 9 pole pairs in FIG. 7B, phase 1 has the same phase relationship as phase 5, phase 9, phase 13, phase 17, phase 21, phase 25, phase 29 and phase 33.

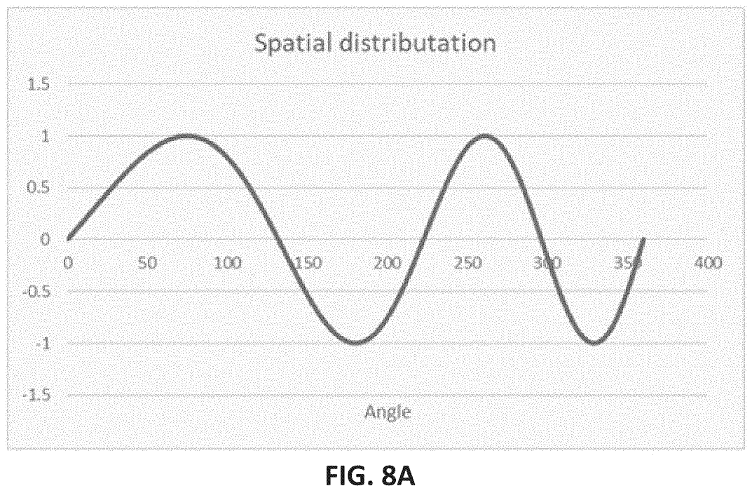

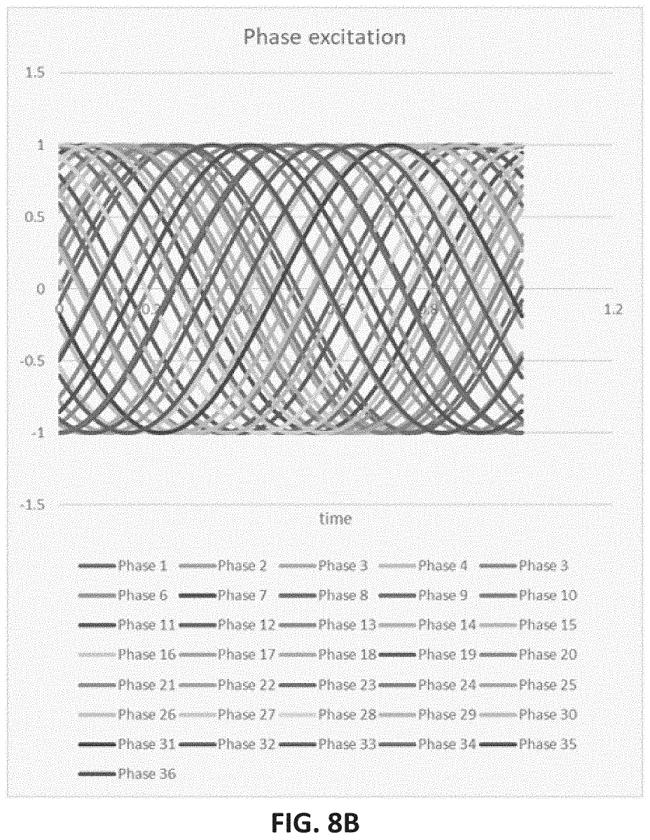

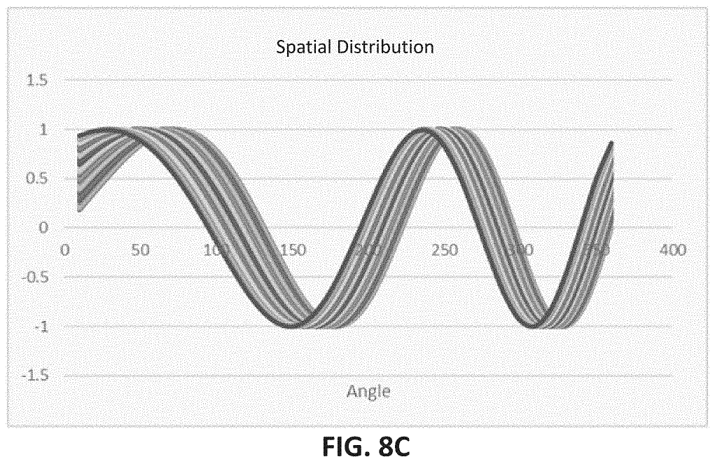

Referring now to FIG. 8A, a plot of the spatial distribution for one stator winding in 36-winging stator is shown for and transitioning from a single pole pair to 2 pole pairs. FIG. 8B is a plot of the phase excitation for each of the 36 individual stator windings of the stator of FIG. 8A while transitioning from a single pole pair to 2 pole pairs. This can be better represented by observing the spatial relationship between individual stator winding locations over time. FIG. 8C is a plot of the spatial distribution for all stator windings in a stator having 36 individual stator windings while transitioning from a single pole pair to 2 pole pairs.

When we rewrap the motor, it is desirable to have both spatial and electrical phase continuity at the boundary. This can readily be achieved by the control of the excitation such that there are no discontinuities, and in particular, controlling that the angle spread at the start of the transition between a pole pair integers (e.g., from 1 to 2 pole pairs) reduces over 1 revolution of the motor, as illustrated in FIG. 8A through FIG. 8C. It should be noted that in order to maintain spatial and phase excitation continuity over one revolution the change in pole pairs must be an integer number. Additionally, because some pole pairs may be more advantageous due to noise and vibration than others, controller 20 and application programming 22 maybe be configured to quickly pass through certain undesirable pole count integers.

Furthermore, it is noted that FIG. 5A through FIG. 8C, and the above associated text directed thereto, show sinusoidal waveforms for ease of conveying the concept. It is appreciated that since each individual stator winding's MMF spatial distribution is controlled, the amplitude, wave-shape and other properties of the individual phases/stator windings may be modified in various ways to deliberately configure/and modify the induced MMF can be deliberately modified at each individual stator winding location, for example to reduce or eliminate torque ripple, Noise, Vibration and Harshness (NVH), or other condition input as requested output 24 at controller 20 so as to provide smother motion/operation of the electric machine 40.

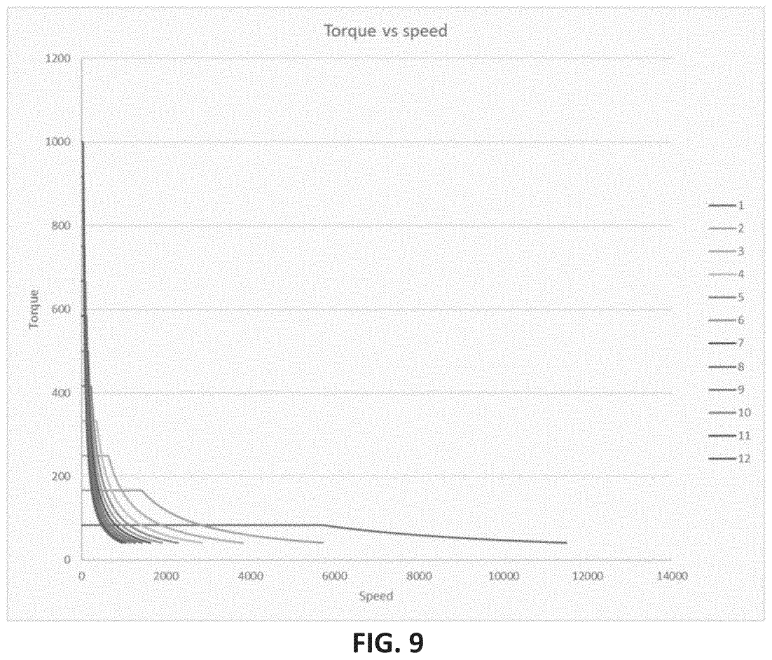

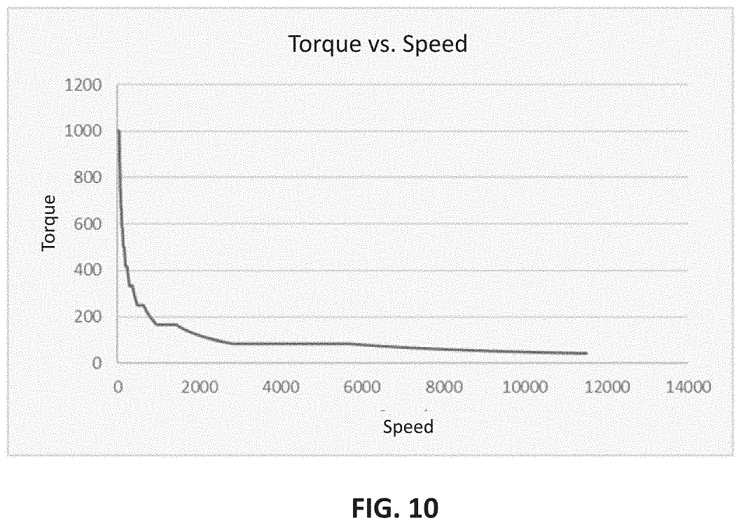

FIG. 9 shows a plot of torque-speed curves for differing pole pair configurations. FIG. 10 shows a plot of the summation of the torque-speed curve utilizing pole count changing. To provide understanding of how switching pole counts provides an effective gear ratio, it is helpful to first understand that the base speed is the speed at which the motor back electromotive force (EMF) equals the applied voltage, which is also the speed at which field weakening starts to be applied. In each of the examples detailed above for in FIG. 5A through FIG. 7B, for the single pole pair, 6 pole pairs and 9 pole pairs excitation patterns, the excitation is the same frequency and hence may be regarded as proportional to the base speed. Given this, the spatial frequency and hence the shaft speed increases with pole pairs. Since in each of the above cases the same excitation is being applied, approximately the same shaft power can be expected. To satisfy the power equation:

Power=Shaft Speed*Shaft Torque;

the shaft torque must fall inversely proportional to the speed. This then gives us different torque speed profiles for the selected pole pair counts, i.e., an effective virtual gear box integral to the motor.

By controlling the current in each individual stator slot or stator tooth and its phase relationship to that of adjoining stator slots/teeth, not only can the resultant air gap flux within the motor be controlled, but also the amplitude, wave-shape and spatial relationship of the individually controllable phases at each stator slot or stator tooth location. This results in one or more of the following non-exclusive advantages:
1) optimizing the wave-shape and timing to minimize motor losses over a wide range of speed and torque;
2) controlling the number of induced rotor poles;
3) smoothly transitioning between integers of induced rotor poles;
4) selecting the optimal pole count to give the highest efficiency for the given speed and torque demand
5) controlling a standing air gap flux within the motor that can change spatially on the fly, i.e. provide virtual gearing.

### Machine Implementation

In an embodiment as detailed in FIG. 2 through FIG. 3B where 36 individual windings are employed, 72 switches (not shown) would be used to drive the 36 windings, e.g. 36 high side switches and 36 low side switches. From a practical standpoint, the actual amount of silicon or SiC that would be used in these switches is the same as that for driving this same motor with a conventional 3-phase winding because the silicon is distributed among 72 switches instead of the standard 6 switches of a 3 phase inverter. For illustration, the 12 pole pair operation in accordance with the presented technology results in 3-phase excitation. If the wiring, instead of being driven by individual switches of 12 parallel output stages per phase, were to instead be combined such that the motor was driven by a standard 3-phase inverter, same amount of silicon or SiC is employed, just rearranged.

In this embodiment, some disadvantage is presented from use of 36 driver stages, current sensors not to mention the connection of the 36 output stages to the motor. In one variation of the present embodiment, a direct copper-bonded (DCB) construction (not shown) may be employed to mount the silicon or SiC die for the above-detailed switch. In such case, the DBC may be configured such that it forms an integral part of the electric machine 40 (e.g. at stator 102) and makes direct connection to all the stator windings as part of the assembly process. The input power may also be connected directly to the DBC construction to minimize the number of power connections. The need for an individual gate driver may also be reduced as each one is used to source and sink less current. Given this, a low-cost integrated gated drive (not shown) may be employed per phase/stator winding, and mounted either directly to the DBC or via a separate PCB (not shown). Current sensors (not shown) may be combined into a single sensor that can be decomposed into individual phase senses via software/application. Alternatively, current mirror switches may be employed.

Furthermore, a highly integrated, easy-to-implement, machine inverter system may be achieved by integrating the motor control CPU or FPGA (e.g. controller 20 in FIG. 1) into the electric machine 40 for numerous varying applications.

### Additional Embodiments

It is appreciated that the above described multi-phase systems and methods may be equally beneficial in numerous vehicle and propulsion related applications, including: electric motors used in other types of vehicles, including trucks, cars, carts, motorcycles, bicycles, drones and other flying devices; in robots and other devices that move autonomously within an environment; etc. As such, the term “vehicle” should be broadly construed to include all of the above and any other type of motorized moving assembly whether known now or developed in the future.

Motors used in appliances such as washing machines, dryers, heating, ventilation and air conditioning (HVAC) applications may provide additional examples of applications that can benefit from pulsed control. There are several components that contribute to pulsed motor control being a good fit for HVAC applications. These include the facts that: (a) the machines used in HVAC applications today are predominantly induction motors that don't contain permanent magnets; (b) a high percentage of the motors used in HVAC applications, including in particular variable speed HVAC condensers and/or air handlers, operate a substantial portion of the time operating regions below their high efficiency areas; and (c) the inertia of a fan or pump normally dominates the motor inertia, which tends to further mitigate potential NVH related impacts associated with pulsing.

Although only a few embodiments of the present technology have been described in detail, it should be appreciated that the present technology may be implemented in many other forms without departing from the spirit or scope of the present technology. The various described multi-phase controllers and associated machine elements may be implemented, grouped, and configured in a wide variety of different architectures in different embodiments. For example, in some embodiments, the controller may be incorporated into a motor controller or an inverter controller or it may be provided as a separate component. Similarly, for a generator, the controller may be incorporated into a generator controller or a rectifier controller and in combined motor/generators the controller may be incorporated into a combined motor/generator controller or a combined inverter/rectifier controller. In some embodiments, the described control functionality may be implemented algorithmically in software or firmware executed on a processor—which may take any suitable form, including, for example, general purpose processors and microprocessors, DSPs, etc.

The machine controller may be part of a larger control system. For example, in vehicular applications, the described control may be part of a vehicle controller, a powertrain controller, a hybrid powertrain controller, or an ECU (engine control unit), etc. that performs a variety of functions related to vehicle control. In such applications, the vehicle or other relevant controller, etc. may take the form of a single processor that executes all of the required control, or it may include multiple processors that are co-located as part of a powertrain or vehicle control module or that are distributed at various locations within the vehicle. The specific functionalities performed by any one of the processors or control units may be widely varied.

Generally, the schemes for multi-phase motor control may be implemented digitally, algorithmically, using analog components or using hybrid approaches. The motor controller may be implemented as code executing on a processor, on programmable logic such as an FPGA (field programmable gate array), in circuitry such as an ASIC (application specific integrated circuit), on a digital signal processor (DSP), using analog components, or any other suitable piece of hardware. In some implementations, the described control schemes may be incorporated into object code to be executed on a digital signal processor (DSP) incorporated into an inverter controller (and/or rectifier controller in the context of a generator and/or a combined inverter/rectifier controller).

Therefore, the present embodiments should be considered illustrative and not restrictive and the present technology is not to be limited to the details given herein, but may be modified within the scope and equivalents of the appended claims.

What is claimed is:

1. An electric machine, comprising:
a rotor having a multiplicity of conductive elements;
a stator having a multiplicity of spaced-apart individual stator windings, there being at least eight stator windings; and
a controller configured to independently control a current supply to each of the stator windings in relation to each of the other stator windings such that an induced magnetic motive force (MMF) between the stator and rotor is individually and spatially controlled at each of the spaced-apart individual stator windings.

2. The electric machine as recited in claim 1, wherein the stator includes a multiplicity of stator teeth, there being a corresponding stator slot between each adjacent pair of stator teeth, and there being a same number of individual stator windings as stator teeth.

3. The electric machine as recited in claim 2, wherein the stator slots and stator teeth are disposed in the stator at spaced-apart radial locations along a circumference of the stator, and wherein the stator is separated from the rotor via an air gap.

4. The electric machine as recited in claim 2, wherein each stator winding is positioned in a corresponding stator slot.

5. The electric machine as recited in claim 2, wherein each stator winding is wound about a corresponding stator tooth.

6. The electric machine as recited in claim 3, wherein the controller is configured to affect timing of independent delivery of current to each of the individual stator windings to control an air gap flux at a plurality of the spaced-apart radial locations.

7. The electric machine as recited in claim 1, wherein the controller is configured to affect timing of independent delivery of current to each of the individual stator windings to have a phase excitation and spatial distribution corresponding to a first pole pair count.

8. The electric machine as recited in claim 7, wherein the controller is further configured advancing or retarding the phase excitation and spatial distribution of the current delivered to each of the individual stator windings to incrementally transition from the first pole count to a second pole count, the first pole count being an integer different than the second pole count.

9. The electric machine as recited in claim 7, wherein the electric machine comprises an electric induction motor.

10. A method of controlling operation of an electric machine, the method comprising:
providing a stator in proximity to a rotor, the stator having a plurality of at least eight individual stator windings disposed at spaced-apart radial locations along a circumference of the stator; and
independently supplying a current to each of the individual stator windings to generate an induced magnetic motive force (MMF) between the stator and rotor that is spatially controlled at each of the spaced-apart radial locations;
timing independent delivery of current to each of the individual windings to have a phase excitation and spatial distribution corresponding to a first pole pair count; and
advancing or retarding the phase excitation and spatial distribution of the current delivered to each of the individual windings to incrementally transition from the first pole count to a second pole count, the first pole count being an integer different than the second pole count.

11. The method as recited in claim 10, wherein the stator includes a multiplicity of stator teeth, there being a corresponding stator slot between each adjacent pair of stator teeth, and there being a same number of individual stator windings as stator teeth.

12. The method as recited in claim 11, wherein each winding is positioned in a corresponding stator slot.

13. The method as recited in claim 11, wherein each winding is wound about a corresponding stator tooth.

14. The method as recited in claim 10, wherein the controller is configured to affect timing of independent delivery of current to each of the individual stator windings to control an air gap flux at a plurality of the spaced-apart radial locations.

15. The method as recited in claim 10, wherein the controller is configured to affect transition from the first pole count to a second pole count within one revolution of the rotor.

16. The method as recited in claim 10, wherein the electric machine comprises an electric induction motor.

17. The method as recited in claim 16, wherein the incrementally transitioning from the first pole count to a second pole count acts to affect a virtual gear shift of the induction motor.

18. The method as recited in claim 17, wherein the virtual gearing is shifted on the fly.

19. An electric machine, comprising:
a stator comprising a cylindrical housing for receiving a rotor;
the stator comprising a plurality of slots disposed at spaced-apart radial locations along a circumference of the stator, wherein each of the slots forms a tooth with an adjacent slot at the spaced-apart radial location;
a plurality of at least eight individual stator windings disposed at each of the spaced-apart radial locations; and
a controller electrically coupled to the individual windings to independently supply current to each individual winding in relation to the other windings such that an induced magnetic motive force (MMF) between the stator and rotor is spatially controlled at each of the spaced-apart radial locations.

20. The electric machine as recited in claim 19, wherein the controller is configured to affect timing of independent delivery of current to each of the individual stator windings to have a phase excitation and spatial distribution corresponding to a first pole pair count; and
wherein the controller is further configured advancing or retarding the phase excitation and spatial distribution of the current delivered to each of the individual windings to incrementally transition from the first pole count to a second pole count, the first pole count being an integer different than the second pole count.
